(19) United States
(12) Patent Application Publication
(10) Pub. No.: US 2004/0199598 A1
(43) Pub. Date: Oct. 7, 2004

(54) System and method for email notification

(76) Inventor: Plato John Kalfas, Girard, OH (US)

Correspondence Address: TAROLLI, SUNDHEIM, COVELL & TUMMINO L.L.P., 526 SUPERIOR AVENUE, SUITE 1111, CLEVEVLAND, OH, 44114, US

(21) Appl. No.: 10/817,595

(22) Filed: Apr. 2, 2004

Related U.S. Application Data
(60) Provisional application No. 60/459,819, filed on Apr. 3, 2003.

(51) Int. Cl. G06F 15/16

(52) U.S. Cl. 709/207

(57) ABSTRACT

Systems and methods are provided for notifying an email user about content of an email message. One approach provides an electronic message notification display that includes a representation of information contained in a subject field of the electronic message. An indicia associated with the electronic message notifies a recipient of the electronic message that information contained in the subject field comprises a complete message for the recipient.

### CROSS-REFERENCE TO RELATED APPLICATION

This application claims the benefit under 35 U.S.C. §119 to U.S. Provisional Patent Application No. 60/459,819, which was filed on Apr. 3, 2003, and entitled “A Method of Electronic Mail Communication which Provides Notice from a Sender of Electronic Mail to a Receiver that the Sender's Entire E-mail Message is contained in the Receiver's Inbox.”

### TECHNICAL FIELD

The present invention relates to communication via electronic mail and, more particularly to a system and method for email notification.

### BACKGROUND

Electronic mail (“email”) has become a common and often preferred method of communication. Various protocols have thus been developed to support email in different media, including both wired and wireless media.

Simple Mail Transfer Protocol (SMTP) is the predominant email protocol used on the Internet. SMTP is a Transmission Control Protocol/Internet Protocol (TCP/IP) communication protocol that defines the message formats used for transfer of email from one Message Transfer Agent (MTA) via the Internet to another MTA. MTA's handle the details of sending email across the internet. Utilizing the typical operation of SMTP, a user located at a personal computer or terminal device, runs an email application program to create an e-mail message. The email application software provides a human interface to the email system. A user employs the human interface in connection with composing, sending, viewing, editing, and deleting email messages. Depending on the device running the email application software, the human interface can be text-based or provide a combined graphical and text-based user interface. The message text and control information for an email message are placed in a queue of outgoing messages. In some instances, the email application program may use methods, such as Post Office Protocol (POP) or Interactive Mail Access Protocol (IMAP), to transfer the message to the queue. The sending network, having one or more hosts that run an MTA, establishes a Transmission Control Protocol (TCP) connection to the reserved SMTP port on the destination host and uses the SMTP to transfer the message across the Internet.

An email message includes several fields, which can vary according to the particular protocol being utilized. A typical email message includes a message header field, a message body field, and attachments, if supported by the protocol. The message header field includes several subfields. In the example of an SMTP email message, each header field includes a field name (e.g., To, From, Cc, Subject, etc.) and a field body (e.g., mailbox address). Field names and field bodies are separated by a colon (“:”). A field body is terminated by a carriage return/line feed. Lines used to continue header fields begin with a space or tab. Addresses in field bodies are separated by commas (“,”). Some header field bodies are interpreted or parsed simply as free text; for example, the field body of a “Subject:” field.

In a graphical user interface (GUI) associated with an email application software, an inbox typically contains a list of emails addressed to the recipient. The inbox can identify various types of information associated with received emails or sent emails based on the information contained in the message header. The email application software also includes graphical or textual elements that enable a user to, for example, compose new messages, edit existing messages, or otherwise modify the content in the display.

Some existing concerns about email are the possibility of receiving a computer virus or worm. A virus is a program or other piece of program code that can be loaded onto a computer without the knowledge of the recipient. A virus can be dangerous in that it may replicate itself as well as transmit itself across networks and affect other computer users. A worm is a special type of virus that can replicate itself easily and use computer memory, but typically cannot attach itself to other programs.

Another concern with the use of email is electronic junk mail or junk news group postings, commonly referred to as spam. Spam usually is email advertising for some product sent to a mailing list or news group. In addition to wasting a user's time with unwanted email, spam also tends to use up a lot of network bandwidth. Accordingly, various software developers provide various filters or other approaches for reducing spam.

### SUMMARY

One aspect of the present invention provides an electronic message notification display that includes a representation of information contained in a subject field of the electronic message. An indicia associated with the electronic message notifies a recipient of the electronic message that information contained in the subject field comprises a complete message for the recipient.

Another aspect of the present invention provides an electronic mail (email) system that includes a user interface that provides a human-machine interface associated with an email application program. A notice component associated with the email application program is operative to set a notice field of an email message based on an input instruction provided by the user interface. The notice field has a value that indicates if a freely parsable field of the email message contains a complete message for at least one intended recipient.

Yet another aspect of the present invention provides a computer-readable medium having computer-executable instructions for performing a method that includes displaying an indicia associated with an email message to notify at least one recipient of the email message that the subject field of the email message contains a complete message intended for at least one intended recipient.

Since a message encoded according to an aspect of the present invention need not be opened by an intended recipient, but still conveys a complete message to the recipient, the systems and methods can mitigate the amount of time a sender spends composing an email via the present invention's intended effect of dispensing with unnecessary text, the amount of time a recipient spends opening and reading email, and the spread of viruses. Additionally, the utilization of an aspect of the present invention by a sender will also notify the recipient that the email is not spam, since senders of spam, in order to profit financially, must have their emails opened.

### BRIEF DESCRIPTION OF THE DRAWINGS

FIG. 1 is a block diagram illustrating an example of an email system that can be implemented in accordance with an aspect of the present invention.

FIG. 2 depicts an example data structure for an email message that can be utilized in accordance with an aspect of the present invention.

FIG. 3 depicts an example of a graphical user interface for an inbox of an email application program that can be implemented in accordance with an aspect of the present invention.

FIG. 4 depicts an example of a graphical user interface for an email message being composed according to an aspect of the present invention.

FIG. 5 depicts another example of a graphical user interface for an email message being composed to have a selected urgency level in accordance with an aspect of the present invention.

FIG. 6 depicts an example of a computer operating environment that can implement the email notification system according to an aspect of the present invention.

FIG. 7 is a flow diagram illustrating a method for composing an email message according to an aspect of the present invention.

FIG. 8 is a flow diagram depicting a method for receiving an email message in accordance with an aspect of the present invention.

### DETAILED DESCRIPTION

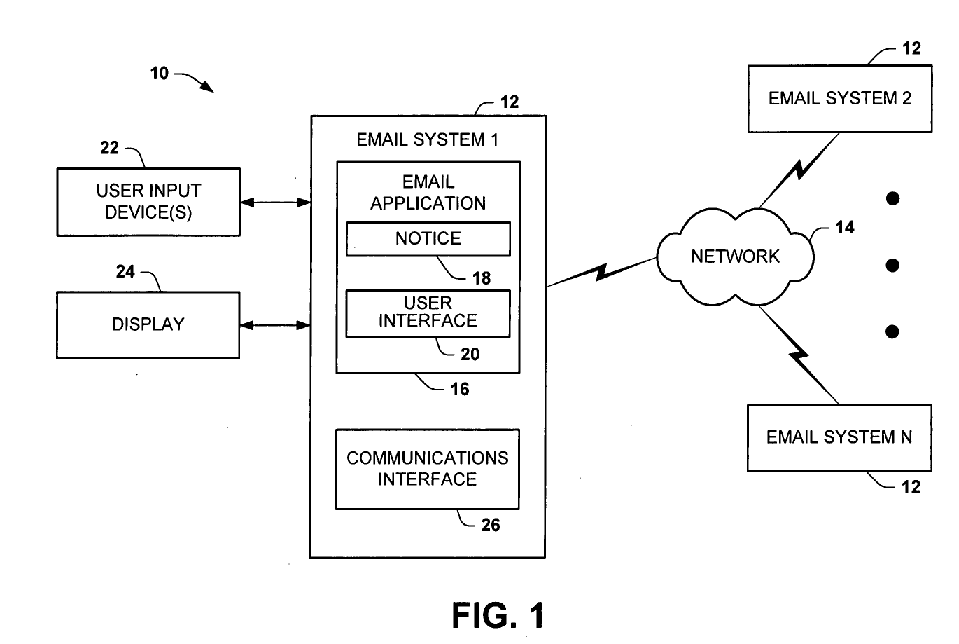

FIG. 1 depicts an example of a basic environment 10 that can implement the notification system and method according to an aspect of the present invention. Within the environment 10, there are a plurality of email systems 12, indicated as email system 1 through email system N, where N is a positive integer denoting the number of email systems in the environment. The email systems 12 can be coupled to each other through a corresponding network 14 through an associated communications link. The communications links can be wired or wireless connections. The connections can be through a public switch telephone network or other infrastructure to enable communication of information between the respective email systems 12. Those skilled in the art will understand and appreciate that the network 14 can correspond to a global internet or other wide area network (WAN) structure, or a local area network (LAN).

The communication of email between the respective email systems employs one or more predetermined protocols such as the SMTP protocol. While the respective email systems are illustrated in FIG. 1 as being coupled to each other through the network 14, it will be understood and appreciated that one or more of the respective email systems could be connected directly to each other.

For simplicity of explanation, only the contents of EMAIL SYSTEM 1 are described herein. It will be understood and appreciated that the other email systems 12 could be similarly configured. Of course, those skilled in the art will understand and appreciate various types of configurations and implementations that can be utilized to provide email notification according to an aspect of the present invention.

EMAIL SYSTEM 1 includes an email application 16 that a user employs to send and receive email via the network 14. The application program 16 can be utilized for reading and writing messages. Alternatively, a separate editor (not shown) can be used. Those skilled in the art will understand and appreciate various implementations and scripts or other program modules that can be utilized in conjunction with the email application 16 for sending, receiving, and composing email messages. All such programs and modules can be considered part of the email application 16.

The email application 16 also includes a notice component 18. The notice component is operative to provide an email notification in accordance with an aspect of the present invention. For example, the notice component 18 can be utilized to set an associated notice field of an email message to alert each recipient of the email message that the information contained in the subject field represents the complete message intended for the recipient. The notice component is also operative to display an indicia based on the value of a notice field in an email message. The indicia notifies a user that the information contained in the subject field of the corresponding email message is a complete message.

Those skilled in the art will understand and appreciate that the notice field associated with a given email message is a freely parsable field such that the information in the notice field can be utilized by the email application 16 for implementing a notice feature (e.g., a graphical indicia) according to an aspect of the present invention. The email application 16 also includes a user interface (e.g., a graphical user interface or GUI) 20 by which a user can compose a new message, edit existing messages, read messages, send messages, or otherwise manipulate email messages that may be stored or associated with the email system 12. A user interacts with the user interface 20 through one or more user input devices 22. For example, the user input devices 22 can include a mouse, keyboard, key pad, joystick, or any other input device. The use of the input devices 22 is facilitated by a display 24 that provides a graphical representation of the user interface 20 so as to enable the user to perform desired functions within the email system 12. The type of display can vary depending on the type of device implementing the email system 12.

The email system 12 is able to communicate messages to other email systems 12 via a communications interface 26. The communications interface, for example, can provide for wireless or wired communication to one or more associated email servers (not shown), which can form part of the network 14. The communications interface 26, for example, can include a network card, a modem, or a combination of communication devices that communicatively couple the email system 12 to the network 14.

By way of further example, a user can employ one or more user input devices 22 to select an appropriate graphical element of the user interface 20 to compose an email message. In order to direct the message to a desired recipient, the user also provides an address for the intended recipient or recipients. The address can be selected from a group of predefined addresses, or alternatively, a user input device can be utilized to provide the address for the recipient. As part of the email message, a user can type a message in the subject field of the email message. The length of the message in the subject field can be limited to a predetermined number of characters, as defined by the email protocol.

A user can, in accordance with an aspect of the present invention, employ the user interface 20 to activate the notice component 18 by selecting an appropriate graphical or other element of the user interface 20. By selecting the notice feature of the user interface 20, the notice component 18 sets a corresponding field of the email message. A feature, which can be graphical, textual and/or audible indicia, can be displayed in connection with the user interface 20 to identify that the notice field has been set accordingly. The notice field provides a programmatic mechanism to alert one or more recipients of the message that the information contained in the subject field includes a complete message for the recipient. For example, the notice field can comprise a single bit to identify two conditions of the notice field. Alternatively, a greater field length can be utilized to provide additional information associated with the message. For example, a multi-bit field can be utilized to identify different degrees of urgency associated with the email message.

A user can also employ the user input device to read or otherwise manipulate an email message that has been received by the email system 12. For instance, the email application 16 cooperates with the user interface to provide a corresponding display of the messages addressed to the user of the email system 12. The messages can be provided as part of a graphical representation, such as an inbox, which includes a list of messages that have been addressed to the user of the email system 12. The amount of information displayed for each of the respective messages in the inbox can be controlled by a user setting appropriate controls associated with the email application 16.

As an example, the inbox of the user interface 20 can organize email messages to display information that identifies a sender and the date for the message, as well as information (e.g., text) contained in the subject field. According to an aspect of the present invention, an indicia, such as a graphical feature, can be displayed in connection with a message based on whether a corresponding notice field in the message had been set by the sender of the email message. As mentioned above, the indicia notifies the user that the information contained in the subject field includes a complete message for the user. For a visually-impaired individual, a corresponding audible indicia can be provided to provide an appropriate notification to the user. Since the notification informs the user that a complete message is contained in the subject field, a user is not required to open such a message, which will save the user time. Additionally, the likelihood of receiving a virus can be mitigated, and the user will appreciate the fact that none of the emails received employing a notification feature according to an aspect of the present invention will be spam. This is because senders of spam require their emails to be opened, and email employing the notification feature described herein notifies the recipient that there is no need to open the email. It further will be appreciated that by utilizing the notification feature, email correspondence can be kept brief and thereby increase the available bandwidth over the network 14.

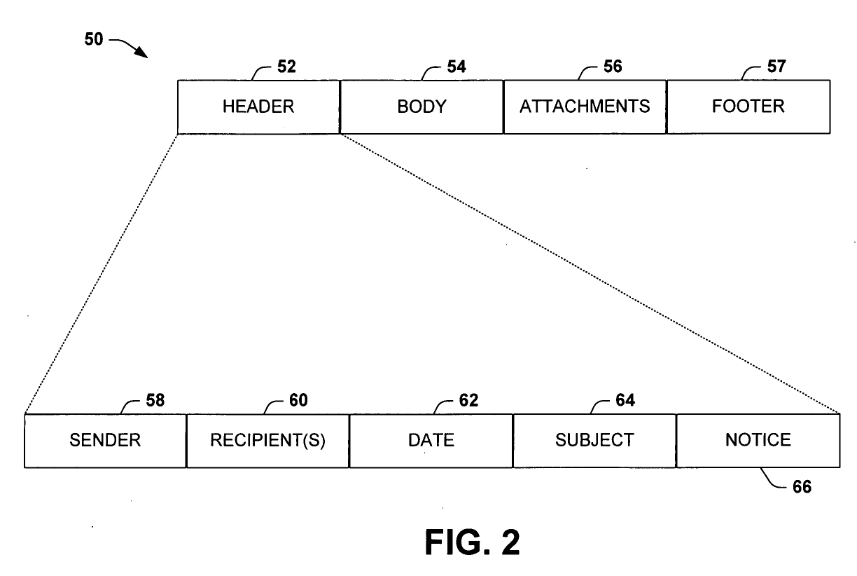

FIG. 2 depicts an example of a data structure 50 for an email message that can be communicated between two or more email systems such as computers or other email appliances (e.g., cell phones, PDAs, etc.). In the example of FIG. 2, the email message 50 includes four main fields: a header field 52, a body field 54, an attachment field 56, and a footer field 57. Those skilled in the art will understand and appreciate that an email message 50 implemented according to an aspect of the present invention need not contain any data in the body field 54, attachment field 56, or footer field 57. That is, the body field 54, attachment field 56, and footer field 57 can be empty fields.

The header field 52 includes several subfields that are utilized for routing the email message from the sender to the recipient or recipients of the message. The header field, for example, can include a sender field 58 that includes an address of the sender of the email message. Recipient(s) field 60 includes addresses for one or more recipients of the email message. Recipients can be identified in one or more subfields of the field 60, such as To, Cc, or Bc subfields. The addresses identified in the Bc field will not be displayed at a recipient's site and, typically, are extracted from the message by the email server or email application prior to being added to the inbox of the recipient's email program. The header field 52 could also include a date field 62 that identifies the date that the message was sent by the sender. The header field 52 also includes a subject field 64. The subject field usually contains text (e.g., encoded as ASCII or other code for representing text characters) provided by the sender who composed the email to provide information to the recipients about the email message.

According to an aspect of the present invention, the subject field 64 may contain a complete message for the recipient or recipients of the email message. In order to alert the recipient or recipients that the subject contains a complete message, the header field 52 also includes a notice field 66. The notice field 66 includes one or more bits encoded to indicate a condition associated with the email message. An email system can provide an indicia, such as a graphical and/or textual representation, on the display associated with the received and unopened email message to notify the recipient accordingly. By utilizing a greater number of bits for the notice field 66, additional information can be provided to the user and converted to an appropriate graphical and/or textual representation. For instance, in addition to notifying a user that the subject field contains a complete message, a level of urgency associated with the message can also be encoded within the data of the notice field 66. For example, a graphical representation can be utilized to implement the notice function, with different colors being utilized to identify a level of urgency.

Alternatively, different graphical representations can be provided to identify a level of urgency or security associated with the email message. While the notice field 66 is depicted in FIG. 2 as being part of the header field 52, those skilled in the art will understand and appreciate that the notice field 66 can be provided at any predefined location of the email message.

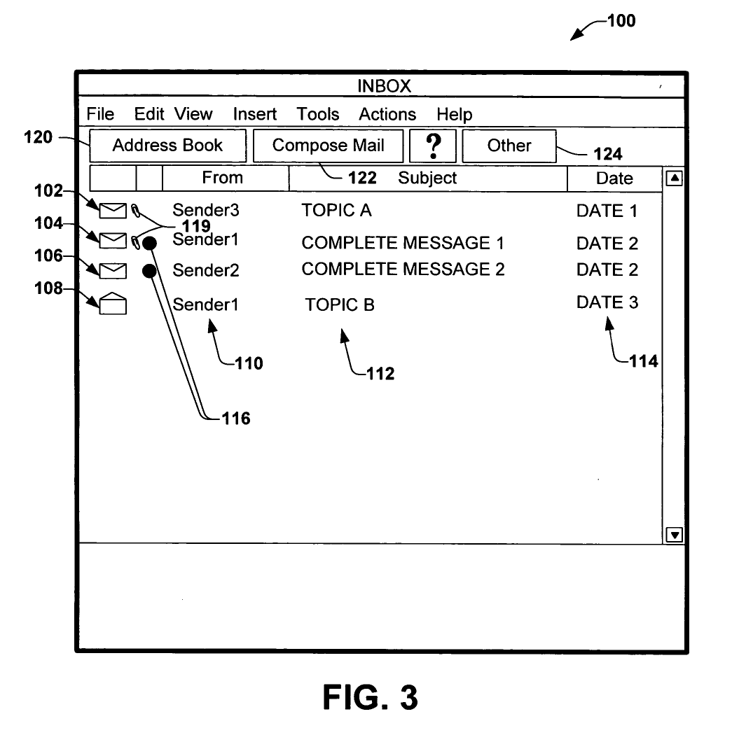

FIGS. 3-6 depict examples of possible graphical representations to demonstrate an example implementation that could be utilized to provide a notification feature in an email system. Those skilled in the art will understand and appreciate that the illustrated graphical representations are for purposes of simplicity of explanation and that any configuration of display and graphical user interface can be utilized in practicing the invention.

FIG. 3 depicts an example of an email GUI 100 associated with an inbox of an email system. The GUI 100 thus contains a list of email messages 102, 104, 106, and 108. The email messages 102-108 are arranged to identify selected information associated with each of the respective email messages. In the example of FIG. 3, the information includes a column 110 identifying the sender of each of the messages 102-108. A subject column 112 identifies information contained in a subject field of the corresponding email messages 102-108, and another column 114 identifies the date associated with the respective email message.

According to an aspect of the present invention, messages 104 and 106 each include respective indicia 116. The indicia 116 convey information to the user that the information contained in the subject field of the respective email messages 104 and 106 contain a complete message for the recipient. Since the complete message for email messages 104 and 106 is contained in the subject field and thus displayed in the subject column 112 of the GUI 100, there is no need for the user to open the respective messages. In contrast, the messages 102 and 108 do not include any indicia 116 to indicate that a complete message is contained in the subject field. Accordingly, a user typically must open the respective messages in order to read the message from the sender. Thus, there is an increased risk with respect to the messages 102 and 108 of a virus being associated with the message, such as the attachment associated with the message 102. Additionally, even if the attachment associated with the message 104 did contain a virus, a user, upon seeing the respective indicia 116, need not open the message or its attachments so as to expose the corresponding computer or other appliance to a potential virus.

Additionally or alternatively, the email GUI 100 can be programmed to cooperate with the associated email application program to enable a user to open one or more attachments directly from the inbox, without first opening a message. As an example, the user can employ the GUI 100 to open attachments associated with the messages 102 and 108, such as by clicking or otherwise activating an attachment user interface element (e.g., depicted as a paper clip) 119. Alternatively, the user interface functionally can be implemented in connection with any textual or graphical element associated with the attachment-containing messages 102 and 108. For instance, a user might employ a mouse or other user input device to activate a drop-down menu (not shown) associated with a message 102 or 108 that provides a list of one or more attachments of the respective message. The user can select to open any number of the attachments from list.

The GUI 100 also includes a plurality of other user interface elements for implementing various functions associated with the email system that provides the GUI 100. For example, the GUI 100 includes a user interface element 120 that is operative to provide information for different addresses of potential recipients, such as can be preprogrammed by a user. The GUI 100 can also include a user interface element 122 operative to compose a new email message. The user interface element 122 thus can be selected by a user to open a new dialog or user interface dialog box associated with composing a new email message. Those skilled in the art will understand and appreciate that various other user interface elements 124 can be provided to implement various other functions typically associated with an email system. As an alternative to graphical user interface elements 120-124, access to other user interface functions can be provided through a series of one or more drop-down menus or other methods.

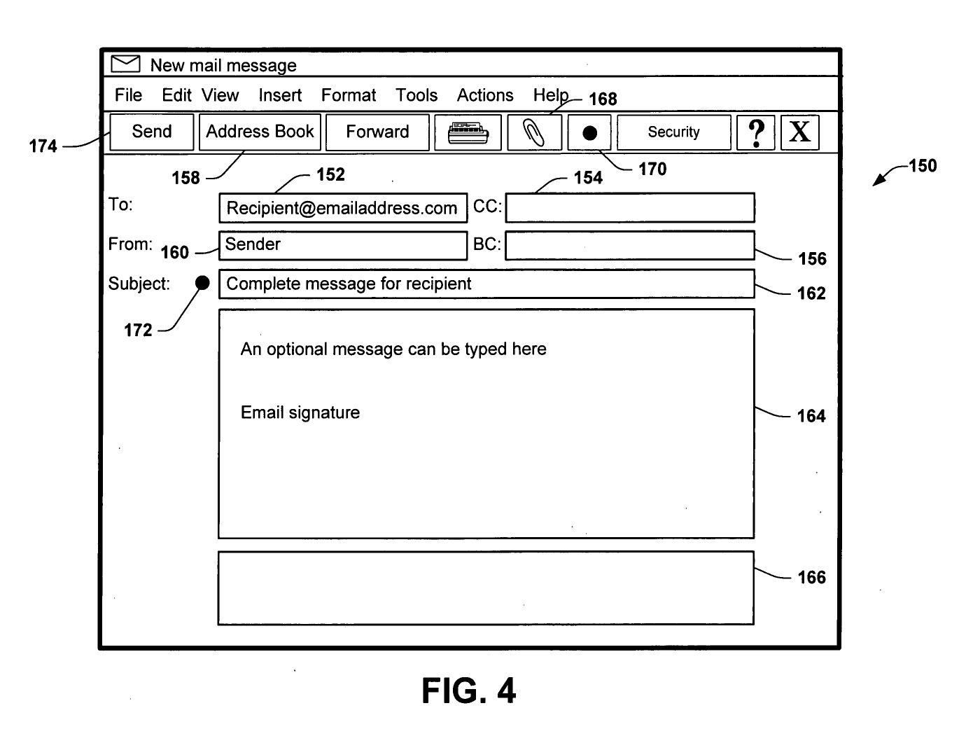

FIG. 4 depicts an example of another email GUI 150 associated with composing a new email message. The new email message GUI 150 includes a plurality of fields. For example, the GUI can include one or more fields 152, 154, and 156 for identifying recipients of the email message being created. The respective fields 152-156 thus correspond to a recipient field of the email message. The user can enter address information for one or more recipients in any of the respective fields 152-156. For example, a user can manually type the respective addresses into the fields 152-156 or, alternatively, an address book can be accessed, such as through an address book user interface element 158.

The new message GUI 150 can also include a field 160 identifying the sender of the message. The subject field, which typically is part of a header of the email message data structure, can be a predetermined length. A user thus, can type a short message in the subject field 162 using an appropriate user interface device, such as a keyboard, voice recognition software or other user input device. The new message GUI 150 also includes an email body field 164. The email body portion 164 is a variable length field in which a user can type a desired length message for one or more recipients. Depending upon the protocol being utilized, the body field 164 can also include graphical items, as well as uniform resource locators (URL's) that provide links to locations on the Internet or other networks (e.g., local or wide area networks). The GUI 150 further can identify a field 166 that can include one or more attachments that can be associated with the email message. Those skilled in the art will understand various types of attachments that can be associated with the email message. For example, the attachments can be associated with the message by utilizing a corresponding user interface element 168. The GUI 150 can include a plurality of other selectable user interface elements, as well as drop down menus, for implementing various functions associated with the email system that provides the GUI 150.

In particular, the new message GUI 150 can include a user interface element 170 for implementing a notice feature according to an aspect of the present invention. For example, the user interface element 170 can be selected by a sender to set a corresponding notice field of the email message being composed for notifying one or more recipients that a complete message for the recipient(s) is contained in the subject field 162. As an example, after selecting the user interface element 170, a corresponding indicia 172, which can be graphical and/or textual, can be displayed on the GUI 150 adjacent to the subject field 162. The indicia 172 informs a sender that the notification feature has been activated or set. After the message is ready, a user can send the message to the one or more recipients identified in the respective fields 152-156, such as by activating a send user interface element 174. Those skilled in the art will understand and appreciate that the notification feature can be selected at any time prior to sending the message. Alternatively, the notification feature can be activated automatically upon sending the message or the email application can prompt the user in response to sending the message.

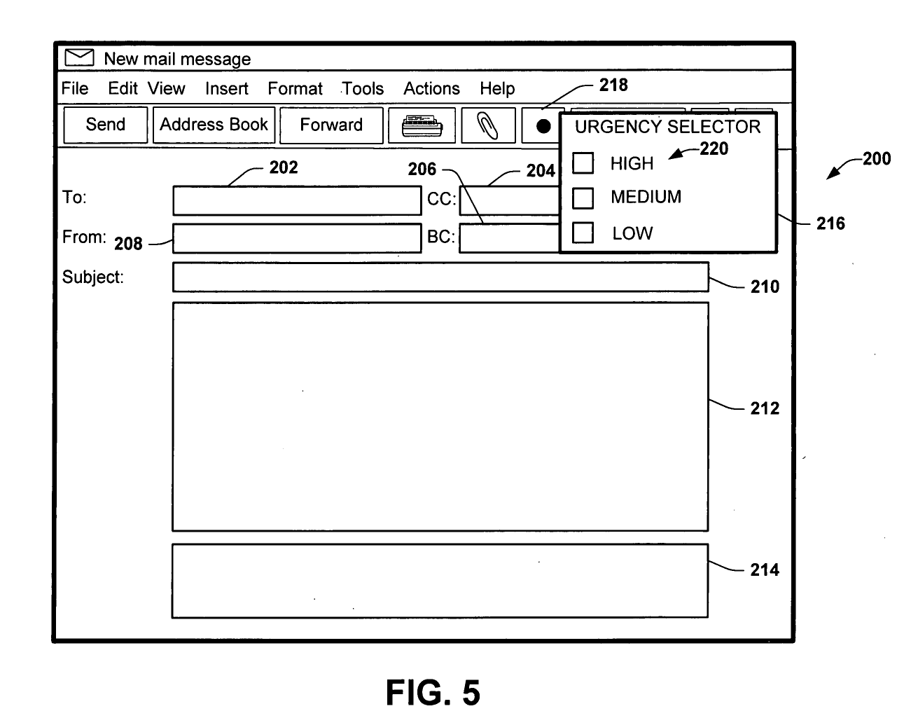

FIG. 5 depicts an example of an email GUI 200 that can be utilized for implementing a notification feature according to another aspect of the present invention. The GUI 200 is substantially similar to the GUI shown and described in FIG. 4. Briefly stated, the GUI 200 includes a plurality of recipient fields 202, 204, 206, and a sender field 208. A subject field 210 is also associated with the mail message. Textual or graphical information can be added to the email message in a body field 212, and attachments associated with the email message can be graphically displayed in the email GUI 200 in a field 214.

As depicted in FIG. 5, an urgency selector 216 can be associated with a notification user interface element 218. For example, upon selecting the notification user interface element 218, the urgency selector 216 can be displayed for enabling the user to select a desired level of urgency for the email message. In the example of FIG. 5, the urgency selector is implemented as a dialog box that includes three possible levels of urgency, namely, high, medium, and low. A user thus can select the desired level of urgency by selecting an appropriate one of the user interface elements 220 in the dialog box of the urgency selector 216. By selecting one of the urgency levels, the urgency information will be encoded in the notification field of the corresponding email message. For instance, the level of urgency can be indicated by utilizing different colors in connection with an indicia that is associated with a display of the email message, such as in the inbox of the recipient. Alternatively, different graphical images or textual messages can be displayed to identify the different level of urgency for the respective email messages based on the selected urgency.

Referring back to FIG. 3, the indicia 116 associated with the respective email messages 104 and 106 can be color coded to identify a corresponding level of urgency, as selected by the sender. Alternatively, different types of graphical indicia 116 can be utilized to indicate different levels of urgency. Those skilled in the art will understand and appreciate that any type of indicia, graphical and/or textual, can be utilized to convey the notification feature to a recipient.

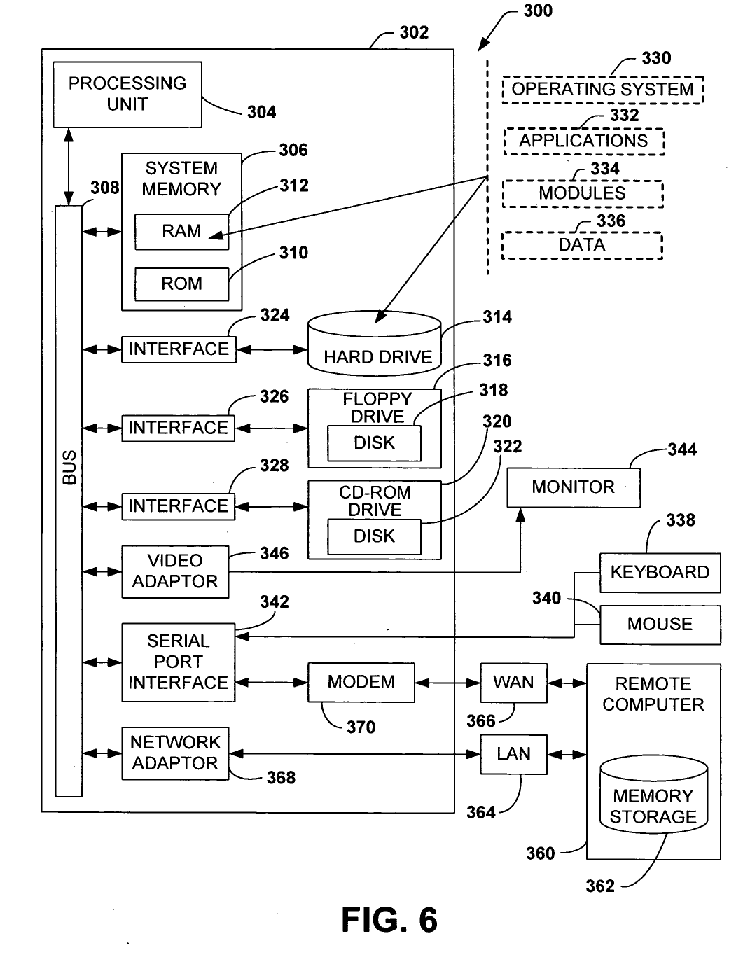

In order to provide additional context for the various aspects of the present invention, FIG. 6 and the following discussion are intended to provide a brief, general description of a suitable computing environment 300 in which the various aspects of the present invention may be implemented. While the invention has been described herein in the general context of computer-executable instructions of a computer program that runs on a computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, and mainframe computers, as well as personal computers, hand-held computing devices, and microprocessor-based or programmable consumer electronics, each of which may be operatively coupled to one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

With reference to FIG. 6, an exemplary system environment 300 for implementing the various aspects of the invention includes a conventional computer 302, including a processing unit 304, a system memory 306, and a system bus 308 that couples various system components, including the system memory, to the processing unit 304. The processing unit 304 may be any commercially available or proprietary processor. In addition, the processing unit 304 may be implemented as a multi-processor formed of more than one processor, such as may be connected in parallel.

The system bus 308 may be any of several types of bus structure including a memory bus or memory controller, a peripheral bus, and a local bus using any of a variety of conventional bus architectures such as PCI, VESA, Microchannel, ISA, and EISA, to name a few. The system memory 306 includes read only memory (ROM) 310 and random access memory (RAM) 312. A basic input/output system (BIOS), containing the basic routines that help to transfer information between elements within the computer 302, such as during start-up, is stored in ROM 310.

The computer 302 also may include, for example, a hard disk drive 314, a magnetic disk drive 316, e.g., to read from or write to a removable disk 318, and an optical disk drive 320, e.g., for reading from or writing to a CD-ROM disk 322 or other optical media. The hard disk drive 314, magnetic disk drive 316, and optical disk drive 320 are connected to the system bus 308 by a hard disk drive interface 324, a magnetic disk drive interface 326, and an optical disk drive interface 328, respectively. The drives and their associated computer-readable media provide nonvolatile storage of data, data structures, computer-executable instructions, etc. for the computer 302. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment 300, and further that any such media may contain computer-executable instructions for performing the methods of the present invention.

A number of program modules may be stored in the drives and RAM 312, including an operating system 330, one or more application programs 332, other program modules 334, and program data 336. The operating system 330 in the computer 302 could be any suitable operating system or combinations of operating systems. The application programs 332 can include one or more email application program modules programmed with executable instructions for providing the notification feature described herein.

A user may enter commands and information into the computer 302 through one or more user input devices, such as a keyboard 338 and a pointing device (e.g., a mouse 340). Other input devices (not shown) may include a microphone, a joystick, a game pad, a satellite dish, a scanner, or the like. These and other input devices are often connected to the processing unit 304 through a serial port interface 342 that is coupled to the system bus 308, but may be connected by other interfaces, such as a parallel port, a game port or a universal serial bus (USB). A monitor 344 or other type of display device is also connected to the system bus 308 via an interface, such as a video adapter 346. In addition to the monitor 344, the computer 302 may include other peripheral output devices (not shown), such as speakers, printers, etc.

The computer 302 may operate in a networked environment using logical connections to one or more remote computers 360. The remote computer 360 may be a workstation, a server computer, a router, a peer device, or other common network node, and typically includes many or all of the elements described relative to the computer 302, although, for purposes of brevity, only a memory storage device 362 is illustrated in FIG. 6. The logical connections depicted in FIG. 6 may include a local area network (LAN) 364 and a wide area network (WAN) 366. Such networking environments are commonplace in offices, enterprise-wide computer networks, intranets, and the Internet.

When used in a LAN networking environment, the computer 302 is connected to the local network 364 through a network interface or adapter 368. When used in a WAN networking environment, the computer 302 typically includes a modem 370, or is connected to a communications server on an associated LAN, or has other means for establishing communications over the WAN 366, such as the Internet. The modem 370, which may be internal or external, is connected to the system bus 308 via the serial port interface 342. In a networked environment, program modules depicted relative to the computer 302, or portions thereof, may be stored in the remote memory storage device 362. It will be appreciated that the network connections shown are exemplary and other means of establishing a communications link between the computers 302 and 360 may be used.

In accordance with the practices of persons skilled in the art of computer programming, the present invention has been described with reference to acts and symbolic representations of operations that are performed by a computer, such as the computer 302 or remote computer 360, unless otherwise indicated. Such acts and operations are sometimes referred to as being computer-executed. It will be appreciated that the acts and symbolically represented operations include the manipulation by the processing unit 304 of electrical signals representing data bits which causes a resulting transformation or reduction of the electrical signal representation, and the maintenance of data bits at memory locations in the memory system (including the system memory 306, hard drive 314, floppy disks 318, CD-ROM 322, and shared storage system 310) to thereby reconfigure or otherwise alter the computer system's operation, as well as other processing of signals. The memory locations where such data bits are maintained are physical locations that have particular electrical, magnetic, or optical properties corresponding to the data bits.

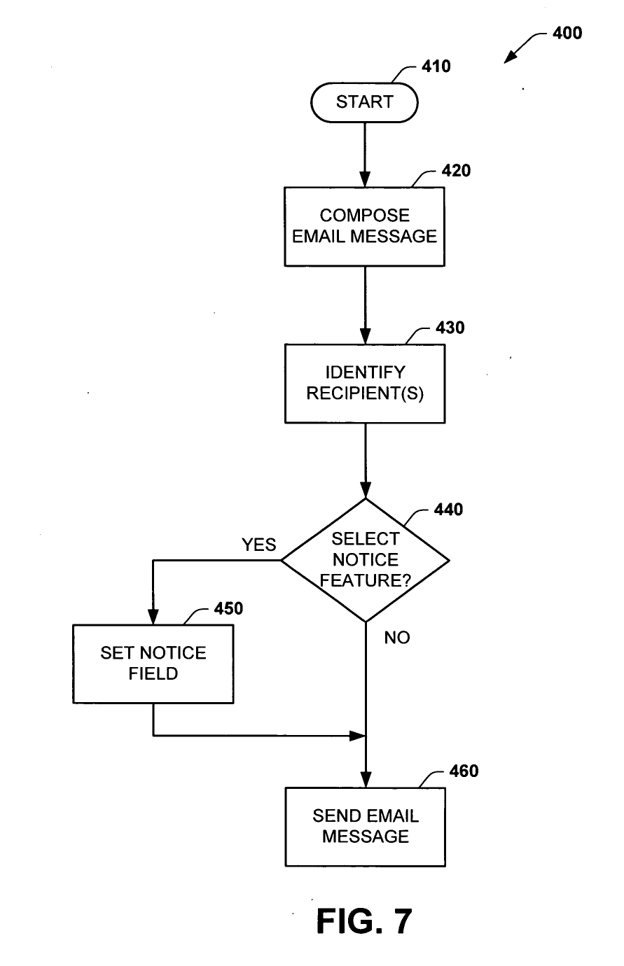

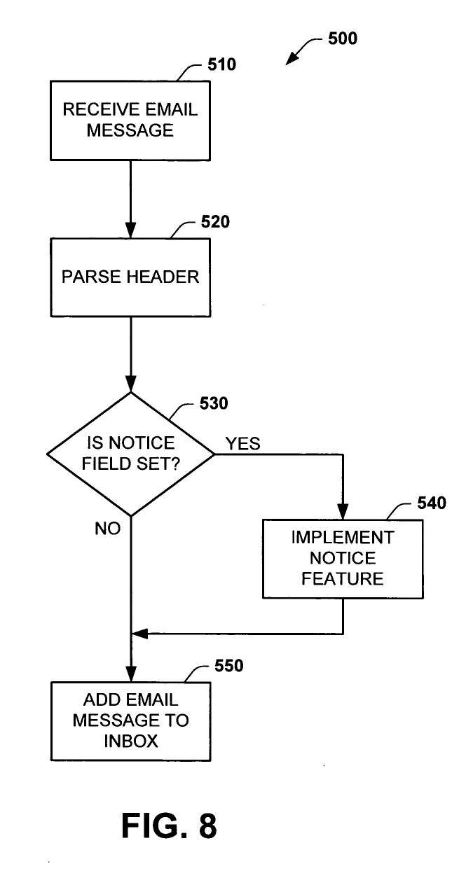

In view of the foregoing structural, functional, and graphical features described above, methodologies in accordance with various aspects of the present invention will be better appreciated with reference to FIGS. 7 and 8. While, for purposes of simplicity of explanation, the methodologies of FIGS. 7 and 8 are shown and described as executing serially, it is to be understood and appreciated that the methodology is not limited by the order shown, as some aspects may, in accordance with the present invention, occur in different orders and/or concurrently from that shown and described herein. Moreover, not all features shown or described may be needed to implement a methodology in accordance with the present invention. Additionally, such methodologies can be implemented a computer or any processor-based appliance programmed with appropriate computer-executable instructions.

FIG. 7 is a flow diagram illustrating a method for creating an email message according to an aspect of the present invention. The method 400 begins at 410, such as in connection with activating an associated email application program on a user device, such as a computer or other processor based appliance. At 420, the user selects to compose a new email message. At 430, the user can identify one or more recipients of the email message such as by providing an address or other information associated with an address for the intended recipient or recipients. At 440, a determination is made as to whether the user has selected a notice feature. The selection of a notice feature, for example, can be implemented by activating an appropriate user interface element. Also associated with selecting the notice feature can be a slow action of a desired level of urgency. If the notice feature has been selected (YES) the method 400 proceeds to 450. At 450, a notice field of the corresponding email message is set. The field can be set by writing an appropriate value to the field of the email message. As described herein, the notice field can include one or more bits of data. Alternatively, if the notice feature has not been selected at 440, (NO) the method proceeds to 460. Similarly, after the notice field has been set, the method 400 also proceeds to 460. At 460, the email message can be sent.

FIG. 8 depicts an example of another method 500 that can be implemented in accordance with an aspect of the present invention. The method 500 generally corresponds to receiving an email message at an email system of a recipient that employs notification feature according to an aspect of the present invention. At 500, an email message (e.g., a data structure) is received at 510. The email application program, such as an email transfer agent, parses a header of the received email message at 520. This can include parsing any text-based fields of the header to enable the associated application program to ascertain and display corresponding information associated with the email message. Typically, the header fields have a syntax that distinguishes them from each other, and is separate from the internal syntax of each particular header field. This separate syntax allows simple parsers to operate on the general structure of messages, without concern for the detailed structure of individual header fields.

At 530, a determination is made as to whether a notice field of the email message has been set. If the notice field has been set (YES), the method proceeds to 540. At 540, a notice feature associated with the email message can be implemented. A notice feature, for example, can include providing an indicia associated with an email message on an inbox of a corresponding graphical user interface. It is to be understood and appreciated that the indicia can be text-based and/or graphical, depending on the capabilities of the email system on which the message is being displayed. If the notice field has not been set (NO), the method proceeds from 530 to 550. Similarly, after the notice feature has been implemented at 540, the method also proceeds to 550. At 550, the email message is added to an inbox associated with the email system of the recipient that received the email message. Accordingly, in the inbox, a corresponding indicia can be associated with the email message to alert the user that the subject field of the message contains a complete message for the user. Additionally, various levels of urgency can be indicated in the indicia, such as by utilizing different graphics and texts.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An electronic message notification display, comprising:
a representation of information corresponding to a subject field of an electronic message; and
an indicia associated with the electronic message that notifies a recipient of the electronic message that information contained in the subject field comprises a complete message for the recipient.

2. The display of claim 1, wherein the indicia is provided on the display based on a notice field of the electronic message.

3. The display of claim 2, wherein the notice field further comprises at least one bit having a value, based on which the indicia is provided.

4. The display of claim 3, wherein the notice field further comprises a plurality of bits, at least a portion thereof designating a level of urgency associated with the electronic message.

5. The display of claim 1, wherein the indicia is located proximal to the representation of information contained in the subject field.

6. The display of claim 5, wherein the indicia further comprises at least one text and graphics.

7. The display of claim 1, wherein the electronic message corresponds to an unopened electronic message, whereby the recipient can access the complete message without opening the electronic message.

8. An electronic mail (email) system, comprising:
a user interface that provides a human-machine interface associated with an email application program; and
a notice component associated with the email application program, the notice component being operative to set a notice field of an email message based on an input instruction provided by the user interface, the notice field having a value that indicates if a freely parsable field of the email message contains a complete message for at least one intended recipient.

9. The system of claim 8, wherein the email program provides an indicia associated with a representation of the email message based on the value of the notice field.

10. The system of claim 9, wherein the indicia is located proximal to a representation of the parsable field in the representation of the email message.

11. The system of claim 10, wherein the parsable field comprises a subject field of the email message.

12. The system of claim 8, wherein the notice field further comprises at least one bit.

13. The system of claim 8, wherein the notice field further comprises a plurality of bits, at least a portion of the plurality of bits designating a level of urgency associated with the electronic message.

14. The system of claim 8, wherein the email program operative to initiate transfer of the email message from a sender to at least one recipient based on at least one corresponding recipient address.

15. A computer-readable medium having computer-executable instructions for performing a method comprising:
displaying an indicia associated with an email message to notify at least one recipient of the email message that the subject field of the email message contains a complete message intended for at least one intended recipient.

16. The computer-readable medium of claim 15, wherein the method further comprises parsing an incoming email message to extract information encoded by a notice field, the displaying of the indicia being performed based on the notice field.

17. The computer-readable medium of claim 15, wherein, prior to the displaying of the indicia, the method further comprises setting a notice field of the email message by a notice function of a sender's email application to a value that indicates whether the subject field of the email message contains the complete message for the at least one intended recipient.

18. The computer-readable medium of claim 17, wherein the setting of the notice field further comprises setting a plurality of bits to a value that designates a level of urgency associated with the email message.

19. The computer-readable medium of claim 15, wherein the method further comprises displaying the indicia proximal to a representation of the subject field in a graphical representation of the email message.

20. The computer-readable medium of claim 15, wherein the graphical representation of the email message corresponds to an unopened email message.
